(19) United States
(12) Patent Application Publication
(10) Pub. No.: US 2006/0163274 A1
(43) Pub. Date: Jul. 27, 2006

(54) WEATHER PROTECTED DEER AND ANIMAL REPELLENT CONTAINER

(76) Inventor: Clayton Wayne Chalupsky, Cedar Rapids, IA (US)

Correspondence Address: SHUTTLEWORTH & INGERSOLL, P.L.C., 115 3RD STREET SE, SUITE 500, P.O. BOX 2107, CEDAR RAPIDS, IA, 52406, US

(21) Appl. No.: 10/906,874

(22) Filed: Mar. 10, 2005

Related U.S. Application Data
(60) Provisional application No. 60/552,394, filed on Mar. 12, 2004.

(51) Int. Cl. B67D 5/06; B67D 5/38; A01N 25/00

(52) U.S. Cl. 222/23; 424/405

(57) ABSTRACT

A device for displaying an animal repellent. The device comprises a housing having a chamber adapted for receiving the animal repellent. The device further comprises a retainer on the underside of the housing which allows permeation of the scent of the animal repellent from the chamber into the air surrounding the chamber, but does not allow the solid animal repellent to sift through the retainer.

### RELATED APPLICATIONS

The present application is a non-provisional of U.S. Provisional Patent Application No. 60/552,394 which was filed on Mar. 12, 2004 and is hereby incorporated by reference.

### BACKGROUND OF THE INVENTION

The present invention relates to a container for protectively displaying an odorous animal repellent.

Animal repellents are typically powders or liquids which contain volatile ingredients that are offensive to animals such as deer, dogs, cats, wolves, gophers, raccoons, squirrels, and rabbits. These repellents are used to prevent damage caused by animals which browse and eat vegetation such as trees, flowers, shrubs, gardens, vines, and lawns. One prior art method of utilizing the volatile repellents is to directly apply the repellent to the vegetation. One problem with this method is that most repellents are toxic and can damage vegetation and may not be used on fruits or other plants intended for human consumption. Another problem with this method is that the effectiveness of such repellents diminishes rapidly in outdoor conditions, particularly when rain dilutes and washes such repellents off of the applied areas. Therefore, it is often necessary to reapply the repellent multiple times during a single season to achieve effective results when using the direct application method.

One device which has attempted to overcome the shortfalls of the above direct application method is described in U.S. Pat. No. 5,379,545 (Gall). The device disclosed in the Gall patent is a container having a ground engaging pin which supports a covered chamber. The chamber is adapted to receive animal repellent and the cover portion of the chamber is adapted to protect the repellent from rain. One problem with this device is that the user must remove the cover and physically insert the repellent into the chamber. The handling of animal repellents such as dried blood can be undesirable for users who find such products to be unpleasant. Further, direct handling of the animal repellent is not desirable for any user if the animal repellent is hazardous to human health.

Another problem with the Gall device is that the animal repellent housed in the chamber is accessible by insects through openings which allow the odor of the repellent to diffuse from the chamber into the outside air. Insects which may be attracted to the repellent may eat or carry away the repellent thereby requiring it to be replaced at an unacceptably fast rate. Insects which are attracted to the repellent may even build a nest inside the chamber thereby inhibiting the odor of the repellent from exiting the chamber. The invasion of insects can be an unclean and unwelcome nuisance for the user of the device who may be using the device near their house.

It is therefore an object of the invention to provide a means for displaying an odorous repellent to deer and other animals in a manner where the repellent is not susceptible to rain, winds, or insects.

It is further an object of the invention to provide a waterproof deer repellent container, complete with repellent, to the consumer in a ready to use condition so that there is no need for the user to handle the repellent.

Yet another object of the present invention is to provide a device which will substantially increase the time that a repellent is effective.

Yet another object of this invention is to protect against toxicity to animals and plants.

Other objects and advantages will be apparent from the disclosure and claims which follow taken together with the appended drawings.

### SUMMARY OF THE INVENTION

The present invention is a device adapted to hold a solid and/or granular odorous animal repellent. In use, the device is placed near flowers, shrubs, trees, or like vegetation so as to repel animals, such as deer, which may eat the plants or may otherwise pose a nuisance. Generally, the device comprises a chamber which is adapted to receive the repellent. The chamber is covered by a waterproof housing at its upper end which keeps the chamber dry during precipitation. The housing also covers the sides of the chamber, but does not completely enclose the lower portion of the chamber. The lower portion of the chamber is sealed by a retainer which is adapted to allow the permeation of the odorous animal repellent. In one embodiment the retainer is comprised of a fibrous material that allows the permeation of the odor of the animal repellent, yet does not allow the sifting of the animal repellent through the fibrous material. Nor does this embodiment allow the invasion of insects through the fibrous material into the chamber. In another embodiment, the retainer comprises a plurality of pores that may allow the invasion of insects into the chamber, but in this embodiment, the animal repellent is enclosed in a fibrous pouch that does not allow the invasion of insects into the pouch.

### BRIEF DESCRIPTION OF THE DRAWING

FIG. 1 is a perspective view showing the device mounted onto a rod;

FIG. 2 is a perspective view of the first embodiment of the device showing the fibrous retainer plate combined with the housing;

FIG. 3 is a perspective view of the first embodiment of the device showing the fibrous retainer plate removed from the housing;

FIG. 4 is a perspective view of the second embodiment of the device showing the porous retainer plate combined with the housing;

FIG. 5 is a perspective view of the second embodiment of the device showing the porous retainer plate removed from the housing;

FIG. 6 is a perspective view of an alternate embodiment of the device showing the retainer plate having a collar; and

FIG. 7 is a side elevational view showing the collar of the retainer plate of FIG. 6 being combined with the chamber.

### DESCRIPTION OF THE PREFERRED EMBODIMENT OF THE INVENTION

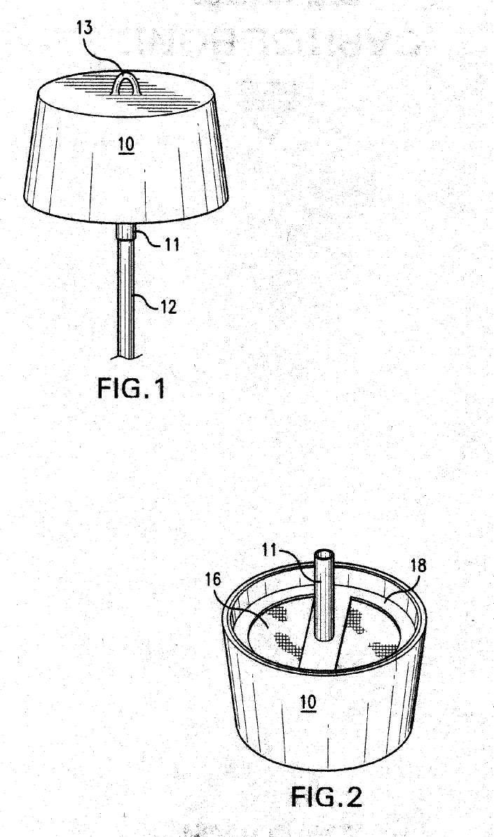

The present invention is a device adapted to hold a solid and/or granular odorous animal repellent 20. It should be noted that all words used in this specification such as upper, lower, top, and bottom, are relative to the device as it is mounted on a rod 12 with the connector 11 facing toward the ground, as shown in FIG. 1.

As seen in FIGS. 1, 3, and 5, the device comprises a cup-like water proof housing 10 having a chamber 15 which is adapted to receive the animal repellent 20. The top and sides of the chamber 15 are enclosed by the housing 10 so as to reduce the likelihood of precipitation entering the chamber 15 where it may contact and adversely impact the effectiveness of the animal repellent 20. As seen in FIGS. 2-5, the housing 10 does not completely enclose the lower portion of the chamber 15. Rather, a retainer plate 14, 16 is combined with the lower portion of the chamber 15. The retainer plate 14, 16 allows the odorous animal repellent 20 housed in the chamber 15 to permeate into the air surrounding the device, yet the retainer 14, 16 keeps the repellent 20 inside the chamber 15.

As shown in FIGS. 1-5, the device further comprises a connector 11 which is preferably combined with the upper portion of the chamber 15 by any suitable means. In the preferred embodiment, the connector 11 is a hollow tube which projects from the top portion of the chamber 15. The connector 11 tube is adapted to accept a rod 12 or stake placed in the ground so as to display the device, with repellent 20, to the animals. The height of the rod 12 can be adjusted so as to position the device at any desired distance above the ground. In the preferred embodiment, the rod 12 is comprised of several interlocking sections so that the user can increase the height of the device by mounting the device on additional sections of rod 12. As seen in FIG. 1, the device may also comprise an opening 13 near the top outside portion of the housing 10. This opening 13 is adapted to receive a wire or string to allow a user to hang the device from a branch or fence.

As discussed above, the primary purpose of the connector 11 is to combine with a rod 12 for mounting the device in the user's yard, however, the connector 11 also serves to help combine and support the elements of the device. In the preferred embodiment, the connector is tapered (not shown) so that it becomes narrower toward its bottom end. The taper helps to secure the retainer 14, 16 and ring 18 to the connector 11 as they are combined with connector 11 because the openings in the retainer 14, 16 and ring 18 are of a fixed diameter.

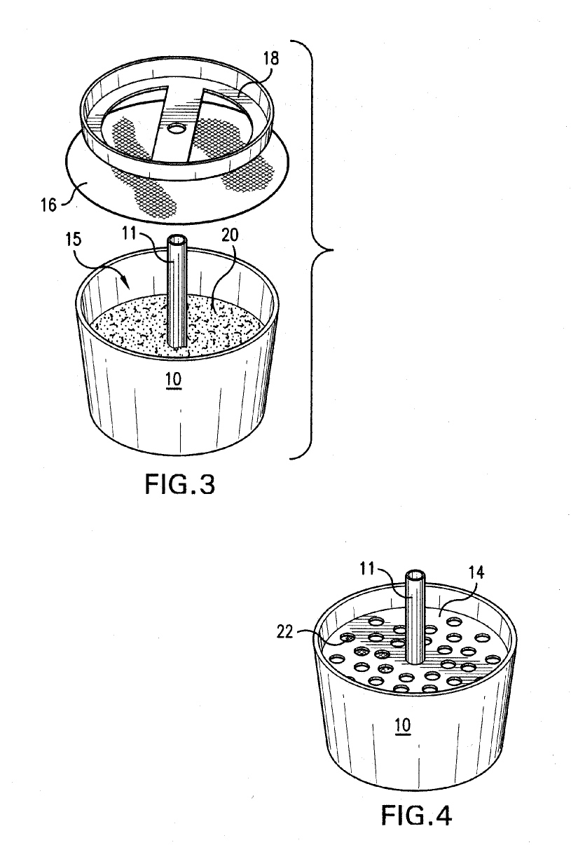

FIGS. 2 and 3 show the first preferred embodiment wherein the retainer plate 16 is made of a fibrous material. The fibrous material allows the permeation of the odorous repellent housed in the chamber 15, but the weave on the fiber is tight enough to prevent sifting of the particles of the animal repellent 20. The weave is also tight enough to prevent insects from penetrating it and entering the chamber 15.

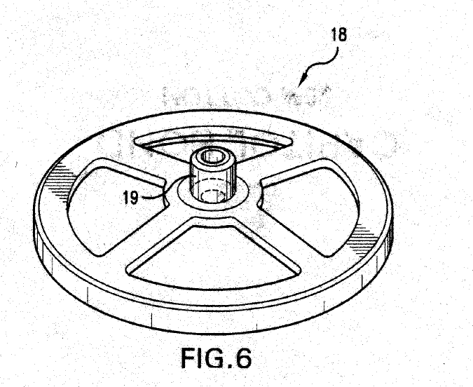

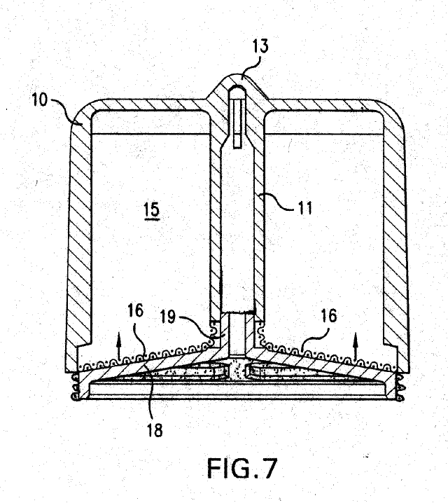

As shown in FIG. 3, the fibrous retainer plate 16, ring 18, and housing 10 are separate pieces. In order to seal the chamber 15 to prevent the invasion of insects, the pieces must fit tightly together. One means for combining the pieces is to secure ring 18 to the housing 10 by an interference fit between the ring 18 and the chamber 15 walls. The radius of the fibrous retainer plate 16 is larger than that of the housing 10 so that a portion of the fibrous retainer plate 16 is captured between the outer rim of the ring 18 and the wall of the chamber 15. An alternate interference fit means for combining the elements of the device is shown in FIGS. 6 and 7 wherein ring 18 further comprises a collar 19. FIG. 7 shows how collar 19 fits into connector 11 inside the chamber 15. (In this variation, connector 11 does not extend outside of the chamber 15.) The collar 19 and connector 11 may receive a rod 12 to help support the weight of the device when it is mounted onto rod 12.

It should be noted that the plastic ring 18 of retainer 16 may be held in place by means other than or in addition to an interference fit. For example, ring 18 may be adhesively combined with housing 10 by adhesively combining the ring 18 to the walls of the chamber 15, or, adhesively combining the connector 11 to the top portion of the chamber 15 and then adhesively combining the connector 11 with the ring 18.

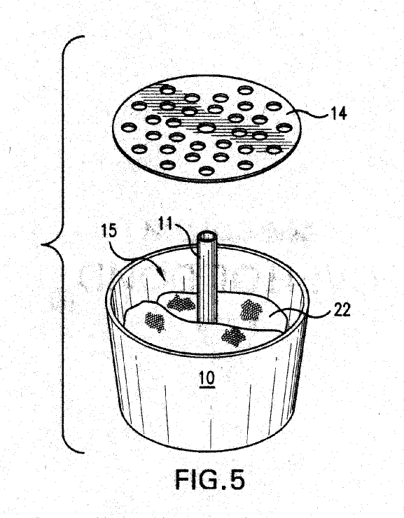

The second embodiment is shown in FIGS. 4 and 5 wherein the retainer plate 14 comprises a plurality of pores. In this embodiment, the animal repellent 20 is enclosed in one or more bags or pouches 22. The pouches 22 are made of a material similar to the above described fibrous material in that the pouch 22 allows the permeation of the odorous repellent, but the weave on pouch 22 is tight enough to prevent the particles of the animal repellent from sifting through the pouch 22. The weave of the pouch 22 material is also tight enough to prevent insects from penetrating it. The retainer plate 14 of this second embodiment can be combined with the lower portion of the chamber 15 by any suitable means, including those described above.

Although any suitable animal repellent product may be used with the present invention, in the preferred embodiment, the animal repellent is a dried blood product in granular form. Dried blood products are particularly suited for repelling deer because, although it is odorless to humans, it has strong odor of danger to deer.

In use, the chamber 15 is filled with the animal repellent 20 and then the retainer 16, 14 is combined with the housing 10 before the device is sold to the end user. Once purchased by the end user, the device is combined with a rod 12 which is placed near the vegetation to be protected. The scent of the repellent coming from the chamber of the device acts to repel animals, such as deer, which may otherwise eat the vegetation near the device. The device allows the display of the odorous animal repellent without any contact to the plants, which is particularly desirable for gardeners who cannot use hazardous spray repellents on edible vegetation because of toxicity and EPA warnings. The housing 10 of the device protects the repellent 20 from getting wet or blown away during rain or high winds. In the first embodiment, the fibrous retainer plate 16 is such that it allows the odor to permeate the air surrounding the chamber 15, but the weave on the fiber is such that it does not allow insects into the chamber 15. In the first embodiment, the animal repellent 20 is placed in the chamber 15 before the sale of the device so that there is no need for the user to contact the repellent 20. In the second embodiment, the pores on the retainer plate 14 may allow insects to enter the chamber 15, however, the repellent is enclosed in pouches 22 which protect the repellent from insect intrusion. This second embodiment allows the user to replace the repellent pouches 22 without having to physically contact the repellent.

Having thus described the invention in connection with the preferred embodiments thereof, it will be evident to those skilled in the art that various revisions can be made to the preferred embodiments described herein with out departing from the spirit and scope of the invention. It is my intention, however, that all such revisions and modifications that are evident to those skilled in the art will be included with in the scope of the following claims.

What is claimed is:

1. A device for displaying an odorous animal repellent, said device comprising:
a housing having a chamber, said chamber having an upper portion and a lower portion,
wherein said chamber is adapted to receive the animal repellent;
an opening in the chamber lower portion;
a retainer for retaining the animal repellent in the chamber by being adapted to be received into the opening in the chamber;
wherein the retainer is adapted to allow the permeation of the animal repellent from the chamber into the outside atmosphere.

2. The device of claim 1 wherein the retainer is a fibrous material.

3. The device of claim 2 further comprising a plastic ring which is adapted to secure the fibrous retainer over the opening in the chamber so that the animal repellent cannot escape from the chamber.

4. The device of claim 1 wherein the retainer is porous.

5. The device of claim 4 further comprising a fibrous pouch, wherein the animal repellent is enclosed in the pouch, and the pouch is received in the chamber.

6. The device of claim 1 wherein the animal repellent is a blood product.

7. The device of claim 1 further comprising an opening on the outer portion of the housing adapted for combining the device to a string.

8. The device of claim 1 further comprising a connector combined with the housing for mounting the device onto a rod.
